(19) United States
(12) Patent Application Publication
(10) Pub. No.: US 2013/0262137 A1
(43) Pub. Date: Oct. 3, 2013

(54) Method of Routing an Electronic Prescription to a Non-Participating Dispensing Pharmacy

(71) Applicant: WENO EXCHANGE LLC, Austin, TX (US)

(72) Inventor: Tina Lorraine GOODMAN, Austin, TX (US)

(73) Assignee: Weno Exchange LLC, Austin, TX (US)

(21) Appl. No.: 13/854,420

(22) Filed: Apr. 1, 2013

Related U.S. Application Data
(60) Provisional application No. 61/618,626, filed on Mar. 30, 2012.

(51) Int. Cl. G06F 19/00

(52) U.S. Cl. CPC G06F 19/3456
USPC 705/2

(57) ABSTRACT

A method of routing an electronic prescription to a non-participating dispensing pharmacy allows a patient the right to choose the pharmacy of their choice, while being able to take full advantage of the benefits offered by e-Prescribing. The current method provides any pharmacy with the ability to retrieve an electronic prescription without being a participating trading partner of an electronic prescribing network. The system accomplishes this through a method comprising the steps of creating an electronic prescription at a point of care location, transmitting said electronic prescription to the prescribing network, determining if the pharmacy is a participating trading partner, generating a secondary prescription version, hosting the electronic prescription on a secure web portal and transmitting an alert to the pharmacy containing the secondary prescription and a set of instructions for accessing the secure web portal. Furthermore, the network delivers a status of the delivery to the Point of care.

The current application claims a priority to the U.S. Provisional Patent application Ser. No. 61/618,626 filed on Mar. 30, 2012. The current application is filed on Apr. 1, 2013 while Mar. 30, 2013 was on a weekend.

### FIELD OF THE INVENTION

The present invention generally relates to the a method of routing electronic prescriptions, more specifically the present invention is a method of routing electronic prescriptions to any dispensing pharmacy regardless of their participation within an electronic prescribing network.

### BACKGROUND OF THE INVENTION

Electronic prescribing offers a prescriber the ability to electronically send an accurate and understandable prescription directly to a pharmacy from the point-of-care. Since the inclusion of electronic prescribing in the Medicare Modernization Act in 2003, medication errors have begun to steadily decline. With the many benefits to patient safety, health care providers and pharmacies have started to take notice of electronic prescribing and have begun to adopt electronic prescriptions (eRx) systems that meet the government requirements for accepting e-Prescriptions. According to the United States government Medicare Part D Prescription Drug Program, an electronic prescribing means the transmission, using electronic media, of prescription or prescription-related information between a prescriber, dispenser, pharmacy benefit manager, or health plan, either directly or through an intermediary, including an electronic prescribing network.

Since the US government announced incentives and penalties to eligible prescribers that adopted or failed to adopt e-Prescribing in 2008, e-Prescribing has increased tenfold. Although there were several electronic prescription systems in use, the majority of the electronic prescription systems suffered from limited functionality. These electronic prescription systems had limited functionality due to requiring the prescriber, the dispensers, the pharmacy benefit managers, and the health plans to be associated with the same electronic prescribing network. As a result of the limited distribution networks, the two largest electronic prescribing networks merged together to form a single electronic prescribing network. As time wore on, e-Prescribing prices rose and no competitors could compel prescribers, dispensers, pharmacy benefit managers, and health plans to leave the large network and take their chances on a start up network. While prescribers were receiving incentives by the government, the pharmacies were paying for the transactions. Pharmacies were forced to pay the high fees or not participate in e-Prescribing and risk losing patients and referring physicians. E-prescribing comes with patient safety and conveniences, but since not all pharmacies participate, the patient's choice of pharmacies is limited if they want to enjoy these technological advances. If a patient chooses a pharmacy that does not use software certified to participate on an electronic prescribing network, the prescriber must call the prescription in to the dispensing pharmacy, fax the prescription in to the dispensing pharmacy, or give the patient a written prescription to take to the dispensing pharmacy of choice.

It is therefore the object of the present invention to provide a system and a method that allows a patient the right to choose a pharmacy of their choice, while being able to take full advantage of the benefits offered by e-Prescribing. The current method provides any pharmacy with the ability to retrieve an electronic prescription without being a participating trading partner of an electronic prescribing network. Furthermore through the incorporation of this method, prescribers would be able to give their patients the full safety and conveniences associated with e-Prescribing as well as being able to meet government regulations governing participation in the electronic prescribing incentive program. The method of sending the electronic prescription to a non-participating pharmacy comprises the steps of creating an electronic prescription. The electronic prescription is then sent to the electronic prescribing network. The electronic prescribing network determines the dispensing pharmacy is not a participating trading partner of the network. The electronic prescribing network then creates secondary prescription version for the electronic prescription and hosts the electronic prescription through the secure web portal. The electronic prescribing network then transmits the web portal address and the secondary prescription version to the dispensing pharmacy through existing communication means such telephone, fax, and electronic messaging systems. The electronic prescribing network communicates the status of the electronic prescription delivery as part of the routing service.

### BRIEF DESCRIPTIONS OF THE DRAWINGS

FIG. 1 is a flow chart diagram displaying the general process overview relative to the interacting components as observed by system as per the current embodiment of the present invention.

FIG. 2 is a flow chart diagram displaying the general process overview relative to the specific actions utilized by system as per the current embodiment of the present invention.

FIG. 3 is a block diagram displaying the component system of the electronic prescribing network per the current embodiment of the present invention.

FIG. 4 is a block diagram displaying the interacting components of the dispensing pharmacy as per the current embodiment of the present invention.

FIG. 5 is a flow chart diagram displaying the steps of the process for generating the electronic prescription at the point of care (POC) system client as viewed by the system in the current embodiment of the present invention.

FIG. 6 is a flow chart diagram displaying the steps of the process for transmitting the electronic prescription to the pharmacy system client as viewed by the system in the current embodiment of the present invention.

FIG. 7 is a flow chart diagram displaying the steps of the process for transmitting the electronic prescription to the non-participant routing system as viewed by the system in the current embodiment of the present invention.

FIG. 8 is a flow chart diagram displaying the steps of the process for generating a secure web portal for hosting the electronic prescription as viewed by the system in the current embodiment of the present invention.

FIG. 9 is a block diagram displaying the component elements that can make up the prescription availability alert as per the current embodiment of the present invention.

FIG. 10 is a flow chart diagram displaying the steps of the process for generating a legally dispensable facsimile prescription as viewed by the system in the current embodiment of the present invention.

FIG. 11 is a flow chart diagram displaying the steps of the process for generating a legally dispensable audio prescription as viewed by the system in the current embodiment of the present invention.

FIG. 12 is a flow chart diagram displaying the steps of the process for monitoring access to the secure web portal as viewed by the system in the current embodiment of the present invention.

### DEFINITIONS

Electronic Prescription: The US Department of Health and Human Services, Medicare Part D prescription drug program more formally defines electronic prescribing as, “ . . . the transmission, using electronic media, of prescription or prescription-related information between a prescriber, dispenser, pharmacy benefit manager or health plan, either directly or through an intermediary, including an e-Prescribing network. E-Prescribing includes, but is not limited to, two way transmissions between the point of care and the dispenser.” The e-Prescription term used for this invention relates specifically to a new prescription or refill prescription drug order that has been e-Prescribed according to the Medicare Part D definition and the status and error messages associated with each.

Point of Care (POC) System Client: A software system or computerized system utilized by the prescriber to compose, transmit and interface for the purposes of e-Prescribing. POC system client must participate in the electronic prescription network as described by the present invention. POC system client must provide all necessary information for the electronic prescribing network to properly process the electronic prescription. This includes the dispensing pharmacy identifier. According to the US Department of Health and Human Services, and their federal rules of e-Prescribing, each e-Prescription for a new prescription or a refill requires the dispenser's National Council of Prescription Drug Program's (NCPDP) ID.

Electronic Prescribing Network: The electronic prescribing network is also known as a switch/intermediary as described by the National Council of Prescription Drug Program (NCPDP) and Medicare. The electronic prescribing network is an entity that accepts an electronic transaction from another organization and electronically routes the transaction to a receiving entity. The electronic prescribing network facilitates the connections for e-Prescribing. Typically this is between trading partners only, but with this invention the electronic prescribing network can connect POCs system clients with all dispensing pharmacies. Besides routing electronic prescriptions, the electronic prescribing network also routes the status of the messages routed. Without reporting status back to senders a prescriber may send multiple prescriptions for the same drug to one or more dispensers. Reporting the status of an e-Prescription delivery to a non participating dispenser/pharmacy is very important and cannot be considered e-Prescribing without this 2 way communication back to the POC system client.

Participant Database: each pharmacy or dispenser participating on an electronic prescribing network is uniquely identified with the NCPDP ID and other required identifiers used in the e-Prescribing process. The electronic prescribing network maintains a directory type to distinguish between participating dispenser/pharmacies and those that are not participating. Example fields on the database include but are not limited to dispensing pharmacy name, dispensing pharmacy address, NCPDP ID, dispensing pharmacy phone number, dispensing pharmacy fax number, and any electronic message types they can process.

Pharmacy Computer Module: a dispensing pharmacy's hardware device, operating system or browser which enables the dispensing pharmacy access to the electronic prescriptions sent to them securely online achieving a true computer to computer transfer of the electronic prescription.

### DETAIL DESCRIPTIONS OF THE INVENTION

All illustrations of the drawings are for the purpose of describing selected versions of the present invention and are not intended to limit the scope of the present invention.

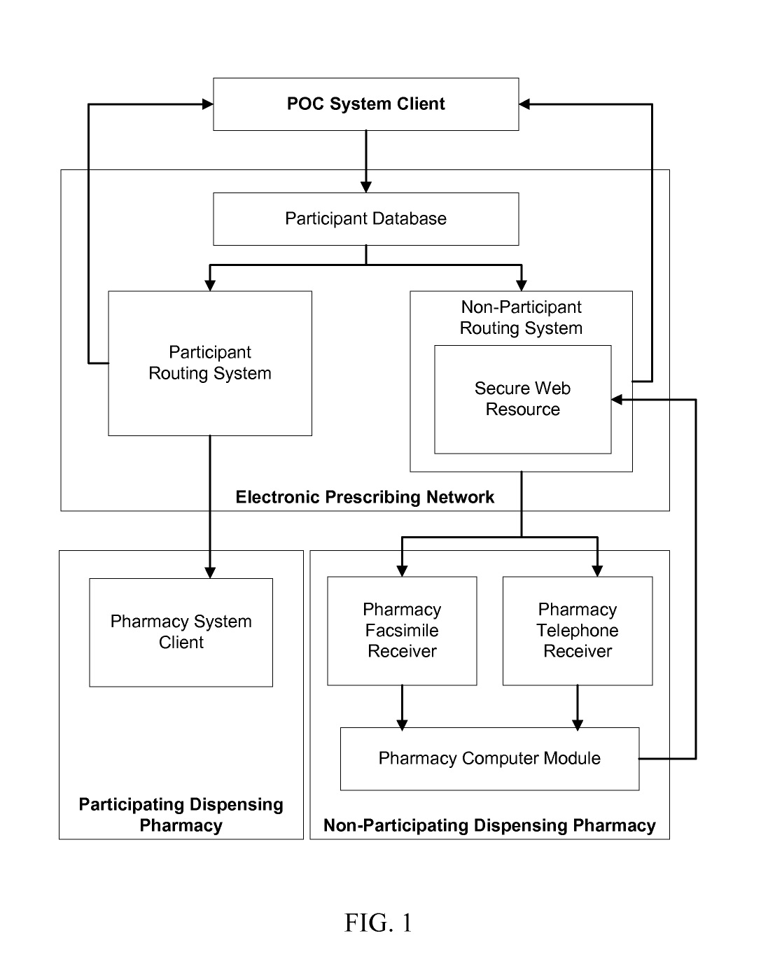

Referencing FIG. 1, the present invention is a system and a method of routing an electronic prescription to any pharmacy regardless of participation in an electronic prescribing network or utilization of specific certified software associated with an electronic prescribing network. The system of the present invention comprises a point of care (POC) system client, networked communication channels, non-networked communication channels, and an electronic prescribing network, in order to interact with a dispensing pharmacy. The POC system client is provided as the means of interacting with the electronic prescribing network as a well as a means of inputting, generating, and transmitting information related to an electronic prescription. The networked communication channels are provided as a means of communicating between elements of the electronic prescribing network and in order to deliver the electronic prescription to the dispensing pharmacy. The non-networked communication channels are provided as a means of communicating with non-participant dispensing pharmacies. The electronic prescribing network is responsible for routing the electronic prescription received from the POC system client to the dispensing pharmacy. The electronic prescribing network comprises a participant routing system, a non participant routing system, and a participant database, wherein the non-participant routing system comprises a secure web resource, and the participant database comprises a plurality of dispensing pharmacy identifiers. The participant database is provided as the means of determining the participation status of a dispensing pharmacy. The secure web resource is provided in order to host the electronic prescription for access by the pharmacy computer. The dispensing pharmacy is inherently associated with a distinct dispensing pharmacy identifier, and comprises a pharmacy system client, a pharmacy telephone receiver, a pharmacy facsimile receiver, and a pharmacy computer module. The dispensing pharmacy is a particular pharmacy location understood by the system as being the destination of the electronic prescription. The distinct dispensing pharmacy identifier is associated with the pharmacy system client, the pharmacy telephone receiver, the pharmacy facsimile receiver, and the pharmacy computer module. The pharmacy system client is utilized by the dispensing pharmacy as the means of receiving the electronic prescription from the electronic prescribing network across the networked communication channels. The pharmacy telephone receiver is the audio device or service that receives a prescription availability alert from the non-participant routing system across the non-networked communication channels. The pharmacy facsimile receiver is a facsimile reception device that receives a prescription availability alert from the non-participant routing system across the non-networked communication channels. The pharmacy computer module retrieves the electronic prescription from a secure web portal through the non-networked communication channels.

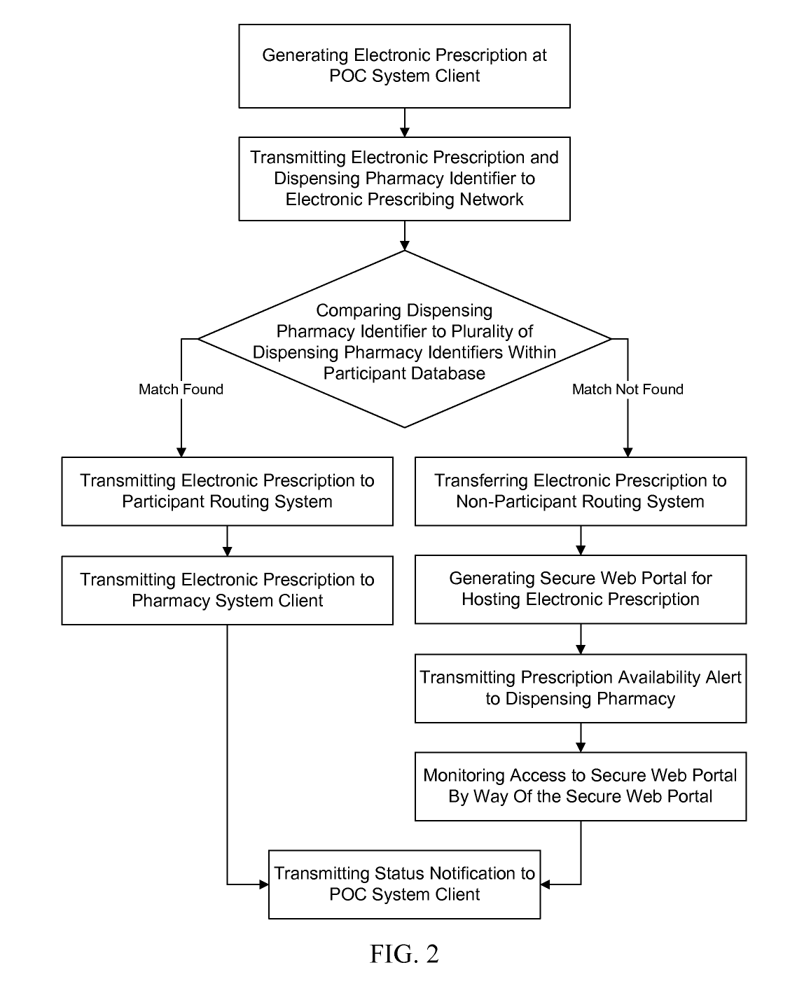

Referencing FIG. 2, the method of routing an electronic prescription to any pharmacy regardless of participation in an electronic prescribing network or utilization of specific certified software associated with an electronic prescribing network comprises the steps of generating an electronic prescription at the POC system client, transmitting the electronic prescription and a dispensing pharmacy identifier to the electronic prescribing network, and comparing the dispensing pharmacy identifier to the plurality of dispensing pharmacy identifiers stored within the participant database. The comparison of the dispensing pharmacy identifier to the plurality of dispensing pharmacy identifier stored within the participant database is the determinant step for routing the electronic prescription from the electronic prescribing network to the participant routing system or the non-participant routing system. If the plurality of dispensing pharmacy identifiers contains the distinct pharmacy identifier, then the electronic prescription is transferred to the participant routing system and then transmitted to the pharmacy system client. If the plurality of dispensing pharmacy identifiers does not contain the distinct pharmacy identifier, then the electronic prescription is transferred to the non-participant routing system, a secure web portal is generated for hosting the electronic prescription, a prescription alert is transmitted to the dispensing pharmacy, and the secure web portal monitors the retrieval of the electronic prescription. In both of the processes resulting from the determinant step, a delivery status for the electronic prescription is generated and transmitted to the POC system client

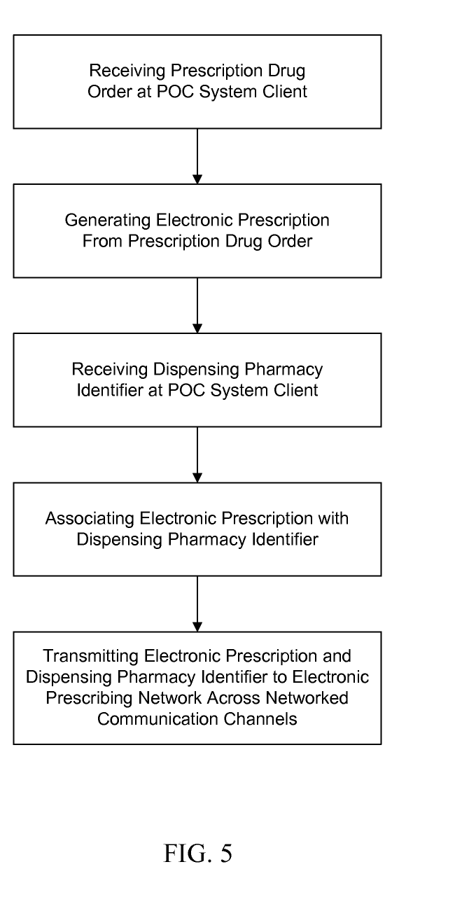

Referencing FIG. 5, the generation of the electronic prescription by a prescriber comprises the steps of receiving a prescription drug order at the POC system client, generating the electronic prescription from the prescription drug order, receiving the dispensing pharmacy identifier at the POC system client, associating the electronic prescription with the dispensing pharmacy identifier, and transmitting the electronic prescription and the dispensing pharmacy identifier from the POC system client to the electronic prescribing network across the networked communication channels. Initially, a prescriber would determine, through diagnostic means, that a drug treatment protocol would be needed for treating a patient. The prescriber would acquire the necessary information about the drug treatment protocol and input it as a prescription drug order through the POC system client. The prescription drug order contains required and relevant information that is needed for creating the electronic prescription. With the prescription drug order entered into the POC system client, the system generates the electronic prescription by formatting the information from the prescription drug order into a standardized digital format that is generally understood as the an electronic prescription. After which, the POC system client receives the intended destination of the electronic prescription in the form of the dispensing pharmacy identifier. The dispensing pharmacy identifier is associated with the electronic prescription. The association of the electronic prescription with the dispensing pharmacy identifier allows the system to route the electronic prescription to its proper destination. After the dispensing pharmacy identifier is associated with the electronic prescription, the POC system client is able to transmit the electronic prescription and the dispensing pharmacy identifier to the electronic prescribing network. The transmission of the electronic prescription and the dispensing pharmacy identifier to the electronic prescribing network occurs across the networked communication channels. The networked communication channels establish a secure transmission path between the POC system client and the electronic prescribing network that allow recognition of the POC system client by the electronic prescribing network as a distinct POC system client.

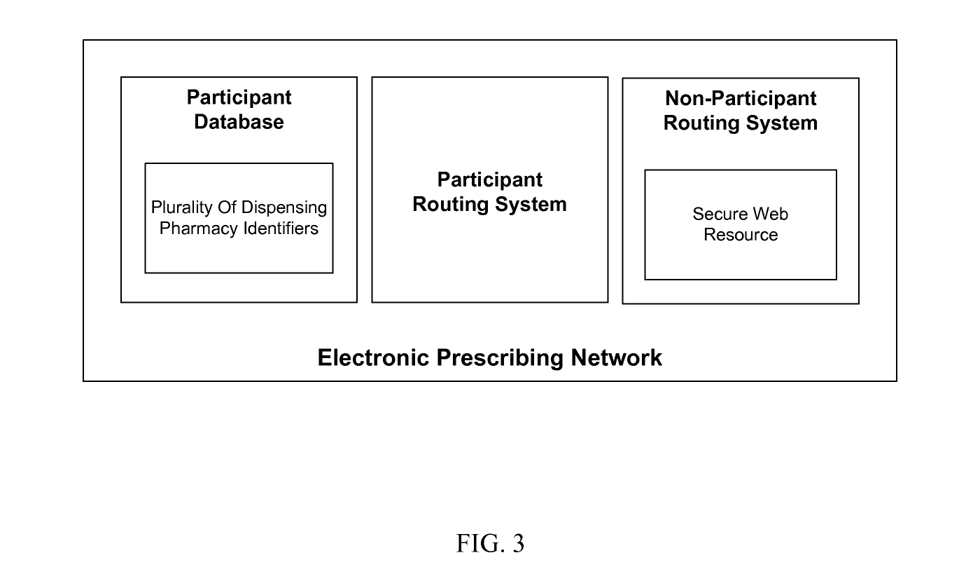

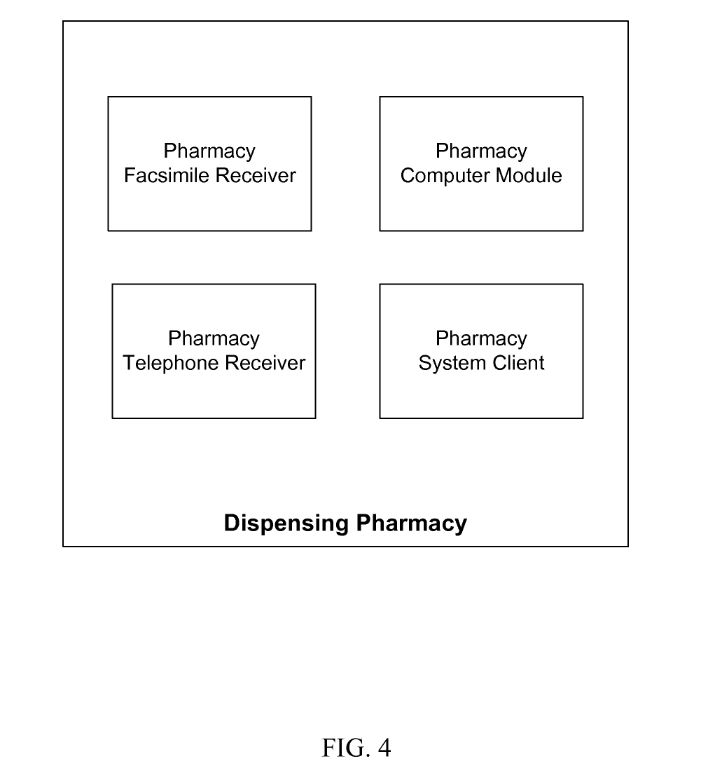

Referencing FIG. 3 and FIG. 4, the comparison of the dispensing pharmacy identifier associated with the electronic prescription to the plurality of dispensing pharmacy identifiers contained within the participant database is provided as the determinant step for routing the electronic prescription to either the participant routing system or the non-participant routing system. In order to accomplish this, the electronic prescribing network is provided with the participant database that contains the plurality of dispensing pharmacy identifiers. The participant database is a searchable database that comprises the plurality of dispensing pharmacy identifiers. The plurality of dispensing pharmacy identifiers correspond to distinct pharmacy identifiers associated with dispensing pharmacies that utilize the pharmacy system client. The pharmacy system client is connected to the electronic prescribing network by way of the networked communication channels. The system compares the dispensing pharmacy identifier associated with the electronic prescription against the plurality of dispensing pharmacy identifiers in order to determine a match. Based on the presence or absence of a distinct pharmacy identifier that matches the dispensing pharmacy identifier associated with the electronic prescription, the system transmits the electronic prescription to the participant routing system or to the non-participant routing system.

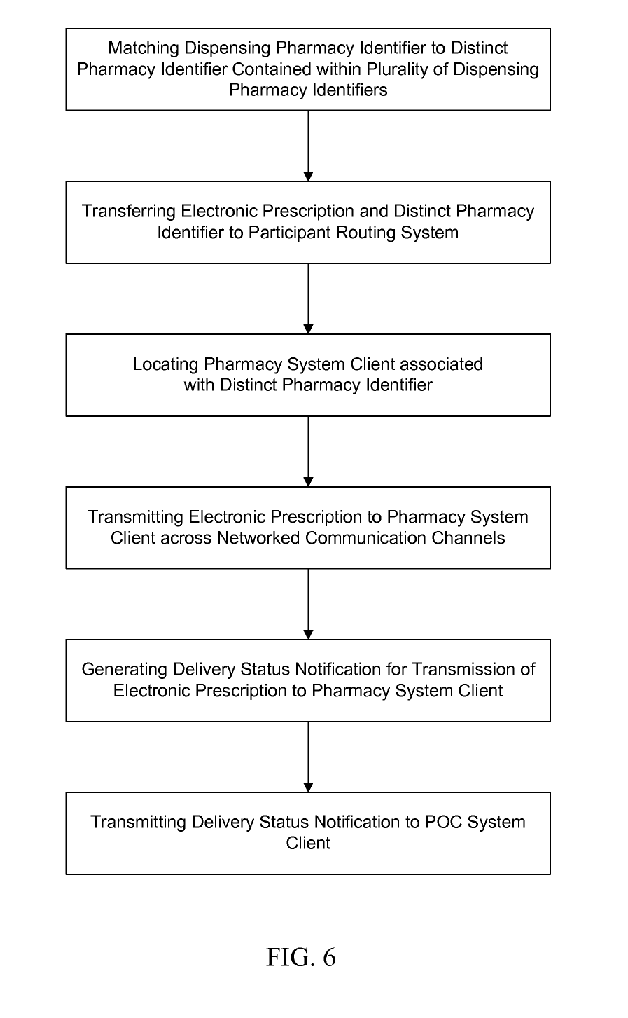

Referencing FIG. 6, the process of transmitting the electronic prescription to the participant routing system comprises the steps of matching the dispensing pharmacy identifier to the distinct pharmacy identifier contained within the plurality of dispensing pharmacy identifiers, transferring the electronic prescription and the distinct pharmacy identifier to the participant routing system, locating the pharmacy system client associated with the distinct pharmacy identifier, transmitting the electronic prescription to the pharmacy system client across the networked communication channels, generating a delivery status notification for the transmission of the electronic prescription to the pharmacy system client, and transmitting the delivery status notification to the POC system client. Upon matching the dispensing pharmacy identifier to the distinct pharmacy identifier contained within the plurality of dispensing pharmacy identifiers, the system transfers the electronic prescription and the distinct pharmacy identifier to the participant routing system. The participant routing system is provided as the system of processes that delivers the electronic prescription to the pharmacy system client associated with the distinct pharmacy identifier. The participant routing system additionally verifies the transmission of the electronic prescription and notifies the POC system client. Prior to transmitting the electronic prescription the participant routing system locates the pharmacy system client associated with the distinct pharmacy identifier. Due to the inherent association between the distinct pharmacy identifier and the pharmacy system client, the matched dispensing pharmacy identifier may already contain the necessary routing information understood by the electronic prescribing network, but a determination step is provided as a confirmation step anticipating additional routing instructions that can be integrated into the distinct pharmacy identifier. Upon locating the pharmacy system client associated with the distinct pharmacy identifier, the participant routing system transmits the electronic prescription across the networked communication channels to the pharmacy system client.

Referencing FIG. 6, After the transmission of the electronic prescription, the participant routing system generates the delivery status. The delivery status notification signifies if the electronic prescription was successfully delivered to the pharmacy system client. Due possible disruptions in the transmission of digital information, the participant routing system confirms a connection to the pharmacy system client across the networked communication channels. In the event that a connection to the pharmacy system client was successfully established, the participant routing system would transmit the electronic prescription and generate a positive delivery status notification. In the event that a connection to the pharmacy system client was unable to be established, the participant routing system would generate a negative delivery status notification. In either event, the delivery status notification would be sent to POC system client alerting the prescriber of the delivery attempt for the electronic prescription.

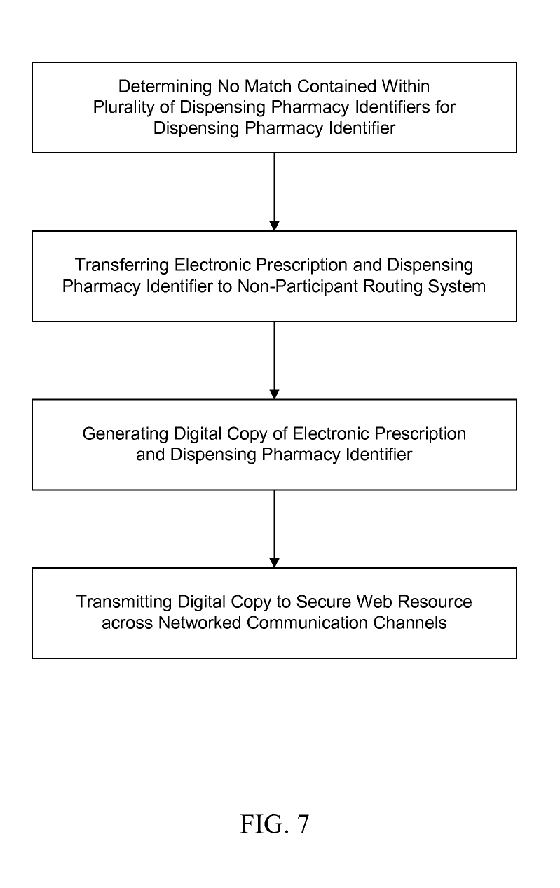

Referencing FIG. 7, the process of transferring the electronic prescription to non-participant routing system comprises the steps of determining no match contained within the plurality of dispensing pharmacy identifiers for the dispensing pharmacy identifier, transferring the electronic prescription and the dispensing pharmacy identifier to the non-participant routing system, generating a digital copy of the electronic prescription and the dispensing pharmacy identifier, transmitting the digital copy to the secure web resource across the networked communication channels. Upon determining that the plurality of dispensing pharmacy identifiers does not contain the distinct pharmacy identifier matching the dispensing pharmacy identifier associated with the electronic prescription, the electronic prescribing network initiates the transfer of the electronic prescription and the dispensing pharmacy identifier to the non-participant routing system. The non-participant routing system is provided as the means of communicating with the dispensing pharmacy through non-networked communication channels, wherein the non-networked communication channels allow non-participating dispensing pharmacies to retrieve and access the electronic prescription. Upon receiving the electronic prescription and the dispensing pharmacy identifier, the non-participant routing system generates a digital copy of the electronic prescription and the dispensing pharmacy identifier. The non-participant routing system generates the digital copy in order to transfer the digital copy to the secure web resource, while maintaining the original version of the electronic prescription and the dispensing pharmacy identifier in order to create a legally dispensable human readable prescription. After the generation of the digital copy, the non-participant routing system transfers the digital copy to the secure web resource. The secure web resource is provided as a component entity to the non-participant system that interacts with the pharmacy computer module across the non-networked communication channels.

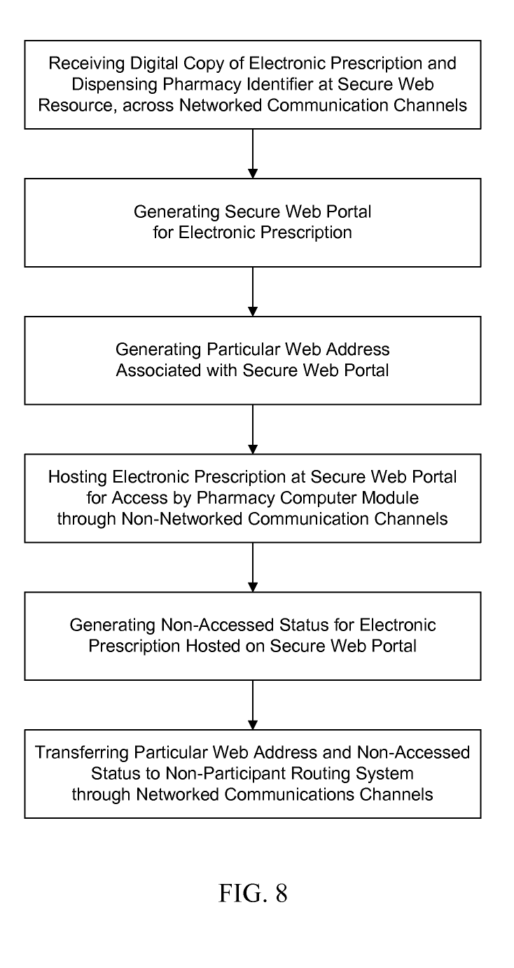

Referencing FIG. 8, the processes of generating the secure web portal comprises the steps of receiving a digital copy of the electronic prescription and the dispensing pharmacy identifier at the secure web resource, across the networked communication channels, generating the secure web portal for the electronic prescription, generating a particular web address associated with the secure web portal, hosting the electronic prescription at the secure web portal for access by the pharmacy computer module through non-networked communication channels, generating a non-accessed status for the electronic prescription hosted on the secure web portal, and transferring the particular web address and the non-accessed status to the non-participant routing system through networked communications channels. Upon receiving the digital copy of the electronic prescription and the dispensing pharmacy identifier, the secure web resource generates a secure web portal for the electronic prescription. The secure web portal is provided as a secured digital space that hosts the electronic prescription for access by the pharmacy computer module associated with the distinct pharmacy identifier that matches the dispensing pharmacy identifier associated with the electronic prescription. The secure web portal is provided with non-specific security measures that prevent unintended access to the electronic prescription by unwanted third parties. The secure web portal can include dedicated security measures that utilize a verification system. After generating the secure web portal, the secure web resource generates a particular web address for the secure web portal. The particular web address is provided as the access path for the pharmacy computer module through the non-networked communication channels. The particular web address allows the pharmacy computer module to the access the electronic prescription over the non-networked communications. After having generated the particular web address, the secure web resource hosts the electronic prescription on the secure web portal. Hosting the electronic prescription on the secure web portal provides the electronic prescription as an accessible and retrievable digital element available through the non-networked communication channels. Upon hosting the electronic prescription on the secure web portal, the secure web resource generates a non-accessed status for the electronic prescription. The non-accessed status is the default status notification for the hosted electronic prescription. After generating a non-accessed status for the hosted electronic prescription, the secure web resource transfers the particular web address and the non-accessed status to the non-participant routing system through networked communications channels.

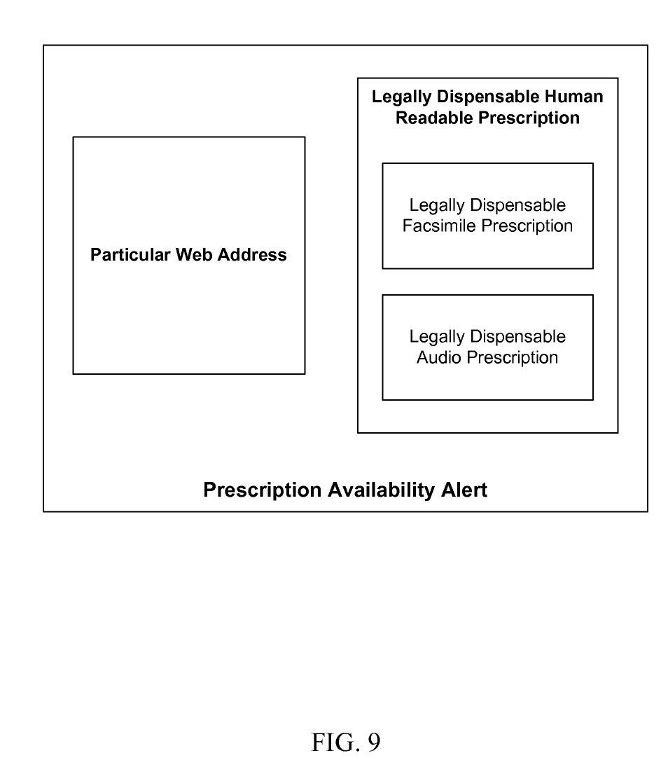

Referencing FIG. 9, the process of transmitting the prescription availability alert further comprises the steps of generating a legally dispensable human readable prescription from the electronic prescription, receiving the particular web address and the non-accessed status from the secure web resource, generating the prescription availability alert from the particular web address and the legally dispensable human readable prescription, matching the dispensing pharmacy identifier to the distinct pharmacy identifier in the established information resource channels, locating the dispensing pharmacy associated with the distinct pharmacy identifier, transmitting the prescription availability alert to dispensing pharmacy across the non-networked communication channel, generating a delivery status for the transmission of the prescription availability alert to the dispensing pharmacy, and transmitting the delivery status and the non-accessed status to the POC system client. After transferring the digital copy of the electronic prescription and the dispensing pharmacy identifier to the secure web resource, the non-participant routing system initiates the process of generating a legally dispensable human readable prescription from the original copy of the electronic prescription. The legally dispensable human readable prescription is provided as a human interpretable version of the electronic prescription that can be understood by a human without an intermediary process or system translating or transcribing the message. The human readable format can be provided as either a textual version or audible version of the electronic prescription as long as either version is derived from the electronic prescription and provided in a legally dispensable format. In order to ensure the dispensing pharmacy is able to process the prescription, the non-participant routing system utilizes three established non-networked communication channels and incorporates established legally dispensable prescription formats accessible by the dispensing pharmacies. After generating the legally dispensable human readable prescription, the non-participant routing system initiates the process of generating the prescription availability alert. Prior to generating the prescription availability alert, the non-participant routing system must receive the particular web address and the non-accessed status from the secure web resource. With the particular web address and the non-accessed status received, the non-participant routing system can utilizes the particular web address and the legally dispensable human readable prescription to create the prescription availability alert. The prescription availability alert provides dispensing pharmacy with a notification for that an electronic prescription is waiting for them and can be accessed across non-networked communication channels at the secure web portal associated with the particular web address. Additionally the prescription availability alert includes the legally dispensable human readable prescription as secondary means of filling the prescription. By including the legally dispensable human readable prescription, the prescription availability alert allows the dispensing pharmacy the ability to elect the preferred means of filling the prescription drug order and serves as a communication failover method if the dispensing pharmacy cannot access the electronic prescription on the secure web portal.

In order to transmit the prescription alert to the dispensing pharmacy, the non-participant routing system must utilize an established information resource to locate non-networked communication channels pathways for contacting the dispensing pharmacy. The established information resource channel is a non-specific resource that can operate similarly to a database but is only required to provide information for contacting the dispensing pharmacy through non-networked communication channels. The established information resource is able to provide the non-participant routing system with the non-networked communication channels associated with the pharmacy telephone receiver, the pharmacy facsimile receiver, and the pharmacy computer module. In order to determine the non-networked communication channels for the pharmacy telephone receiver, the pharmacy facsimile receiver, and the pharmacy computer module, the non-participant routing system searches the established information resource channel using the dispensing pharmacy identifier associated with the electronic prescription. Upon matching the dispensing pharmacy identifier to distinct pharmacy identifier in the established information resource channel, the non-participant routing system locates the dispensing pharmacy associated with the distinct pharmacy identifier. Through locating the dispensing pharmacy associated with the distinct pharmacy identifier, the non-participant routing system is able transmit the prescription availability alert to pharmacy telephone receiver, the pharmacy facsimile receiver, and/or the pharmacy computer module across the non-networked communication channels. During the transmission of the prescription availability alert to the dispensing pharmacy, the non-participant routing system generates a delivery status. The delivery status establishes whether the prescription availability alert was received by the dispensing pharmacy over the non-networked communication channels. Due possible disruptions in the transmission of information over the non-networked communication channels, the non-participant routing system attempts to confirm the delivery of the prescription availability alert to the dispensing pharmacy. In the event that a transmission to the dispensing pharmacy over non-networked communication channels was successful, the non-participant routing system generates a positive delivery status. In the event that a transmission to the dispensing pharmacy over non-networked communication channels was not successful, the non-participant routing system generates a negative delivery status. In either event, the delivery status notification would be sent to POC system client alerting the prescriber of the delivery attempt.

The process of transmitting the prescription availability alert occurs through several non-networked communication channels. While each process contains similarities distinctions must be made as to the destination of the prescription availability alert and the particular format of the legally dispensable human readable prescription.

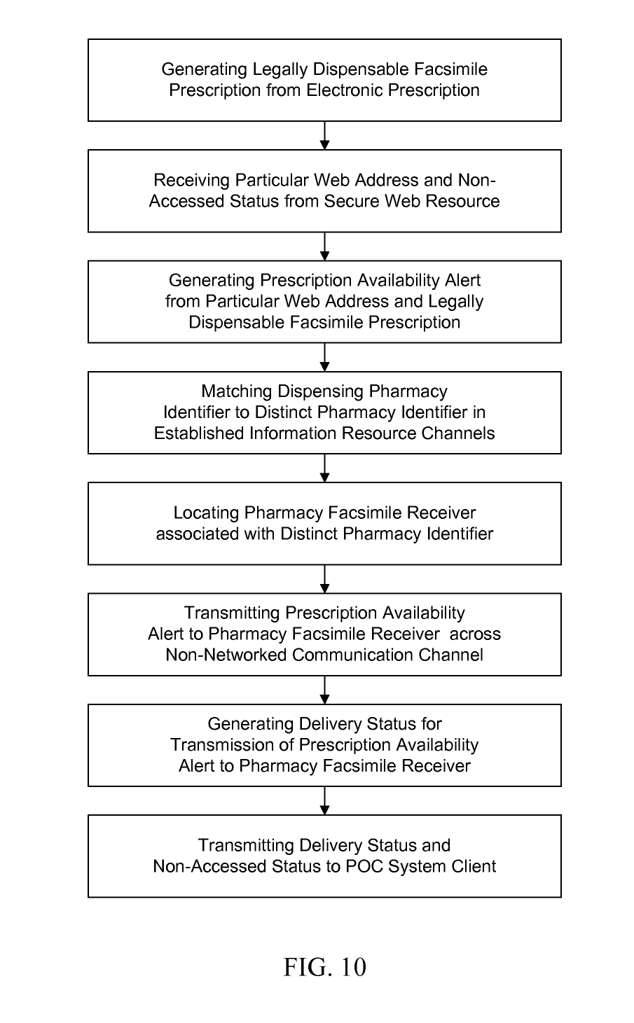

Referencing FIG. 10, the process of transmitting the prescription availability alert to the pharmacy facsimile receiver comprises the steps of generating a legally dispensable facsimile prescription from the electronic prescription, receiving the particular web address and the non-accessed status from the secure web resource, generating the prescription availability alert from the particular web address and the legally dispensable facsimile prescription, matching the dispensing pharmacy identifier to the distinct pharmacy identifier in the established information resource channels, locating the pharmacy facsimile receiver associated with the distinct pharmacy identifier, transmitting the prescription availability alert to the pharmacy facsimile receiver across the non-networked communication channel, generating a delivery status for the transmission of the prescription availability alert to the pharmacy facsimile receiver, and transmitting the delivery status and the non-accessed status to the POC system client. The non-participant routing system is able to generate a legally dispensable facsimile prescription by utilizing the information contained within the electronic prescription and established standards for the generating legally dispensable facsimile prescriptions. The legally dispensable facsimile prescription is provided in a particular format generated from the electronic prescription that constitutes a legally dispensable prescription that can transmitted to a pharmacy's facsimile receiver. Prior to generating the prescription availability alert, the non-participant routing system must receive the particular web address and the non-accessed status from the secure web resource. With the particular web address and the non-accessed status received, the non-participant routing system can generate the prescription availability alert to be transmitted to the pharmacy facsimile receiver from the particular web address and the legally dispensable facsimile prescription. The prescription availability alert to be transmitted to the pharmacy facsimile receiver is provides the dispensing pharmacy with a notification that an electronic prescription is waiting for them and can be accessed across non-networked communication channels at the secure web portal associated with the particular web address. Additionally the prescription availability alert includes the legally dispensable facsimile prescription as a secondary means of filling the prescription. By including the legally dispensable facsimile prescription, the prescription availability alerts allows the dispensing pharmacy the ability to elect the preferred means of filling the prescription drug order. After generating the prescription availability alert, the non-participant routing system matches the dispensing pharmacy identifier to the distinct pharmacy identifier in the established information resource channel. The non-participant routing system then locates the pharmacy facsimile receiver associated with the distinct pharmacy identifier provided by the established information resource channels. The location of the pharmacy facsimile receiver is a destination interpretation by a computer readable system that could be generally understood, in human readable terms, as the fax number associated with the particular dispensing pharmacy. Upon locating the pharmacy facsimile receiver in the established information resource channel, the non-participant routing system is able transmit the prescription availability alert to the pharmacy facsimile receiver across the non-networked communication channels. During the transmission of the prescription availability alert to the pharmacy facsimile receiver, the non-participant routing system generates a delivery status. The delivery status establishes whether the prescription availability alert was received by the pharmacy facsimile receiver over the non-networked communication channels. Due possible disruptions in facsimile transmissions, the non-participant routing system attempts to confirm the delivery of the prescription availability alert to the pharmacy facsimile receiver. In the event that a transmission to the pharmacy facsimile receiver over non-networked communication channels was successful, the non-participant routing system generates a positive delivery status. In the event that a transmission to the pharmacy facsimile receiver over non-networked communication channels was not successful, the non-participant routing system generates a negative delivery status. In either event, the delivery status notification would be sent to POC system client alerting the prescriber of the delivery attempt.

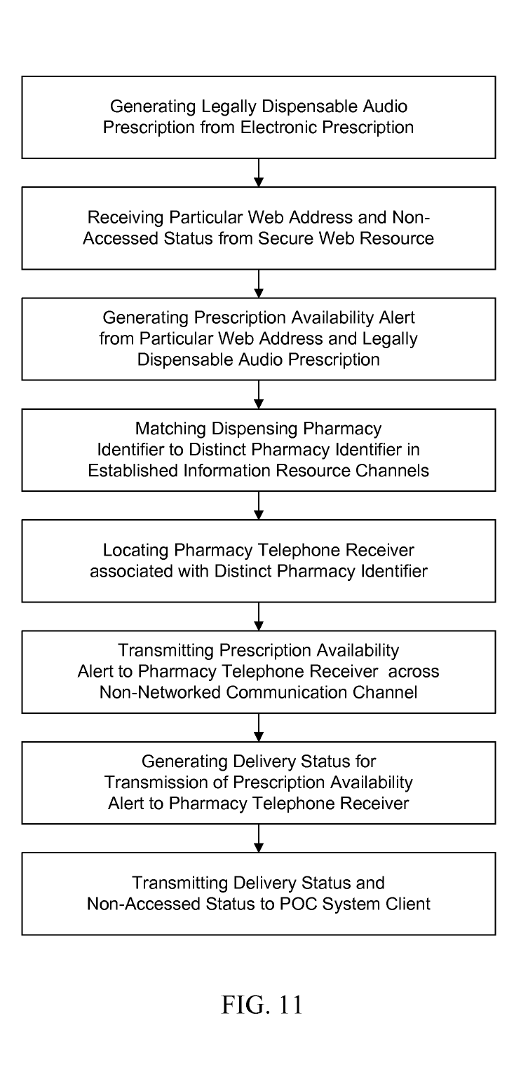

Referencing FIG. 11, the process of transmitting the prescription availability alert to the pharmacy telephone receiver comprises the steps of generating a legally dispensable audio prescription from the electronic prescription, receiving the particular web address and the non-accessed status from the secure web resource, generating the prescription availability alert from the particular web address and the legally dispensable audio prescription, matching the dispensing pharmacy identifier to the distinct pharmacy identifier in the established information resource channel, locating the pharmacy telephone receiver associated with the distinct pharmacy identifier, transmitting the prescription availability alert to the pharmacy telephone receiver across the non-networked communication channel, generating a delivery status for the transmission of the prescription availability alert to the pharmacy telephone receiver, and transmitting the delivery status and the non-accessed status to the POC system client. The non-participant routing system is able to generate a legally dispensable audio prescription by utilizing the information contained within the electronic prescription and established standards for the generating legally dispensable audio prescriptions. The legally dispensable audio prescription is provided in a particular format generated from the electronic prescription that constitutes a legally dispensable prescription that can transmitted to a pharmacy's telephone receiver. Prior to generating the prescription availability alert, the non-participant routing system must receive the particular web address and the non-accessed status from the secure web resource. With the particular web address and the non-accessed status received, the non-participant routing system can generate the prescription availability alert to be transmitted to the pharmacy telephone receiver from the particular web address and the legally dispensable audio prescription. The prescription availability alert to be transmitted to the pharmacy telephone receiver provides the dispensing pharmacy with a notification that an electronic prescription is waiting for them and can be accessed across non-networked communication channels at the secure web portal associated with the particular web address. Additionally the prescription availability alert includes the legally dispensable audio prescription as a secondary means of filling the prescription. By including the legally dispensable audio prescription, the prescription availability alerts allows the dispensing pharmacy the ability to elect the preferred means of filling the prescription drug order. After generating the prescription availability alert, the non-participant routing system matches the dispensing pharmacy identifier to the distinct pharmacy identifier in the established information resource channel. The non-participant routing system then locates the pharmacy telephone receiver associated with the distinct pharmacy identifier provided by the established information resource channels. The location of the pharmacy telephone receiver is a destination interpretation by a computer readable system that could be generally understood, in human readable terms, as the telephone number associated with the particular dispensing pharmacy but can additionally include separate instruction for navigating telephone system menu options. Upon locating the pharmacy telephone receiver in the established information resource channel, the non-participant routing system is able transmit the prescription availability alert to the pharmacy telephone receiver across the non-networked communication channels. During the transmission of the prescription availability alert to the pharmacy telephone receiver, the non-participant routing system generates a delivery status. The delivery status establishes whether the prescription availability alert was received by the pharmacy telephone receiver over the non-networked communication channels. Due possible disruptions in telephone transmissions, the non-participant routing system attempts to confirm the delivery of the prescription availability alert to the pharmacy telephone receiver. In the event that a transmission to the pharmacy telephone receiver over non-networked communication channels was successful, the non-participant routing system generates a positive delivery status. In the event that a transmission to the pharmacy telephone receiver over non-networked communication channels was not successful, the non-participant routing system generates a negative delivery status. In either event, the delivery status notification would be sent to POC system client alerting the prescriber of the delivery attempt.

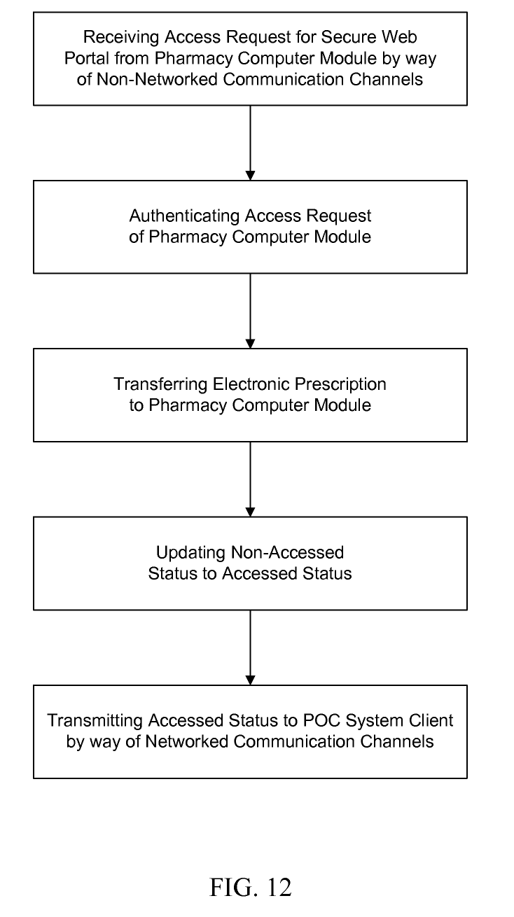

Referencing FIG. 12, the secure web resource monitors access to the secure web portal to determine if the dispensing pharmacy has accessed and retrieved the electronic prescription in order to provide the prescriber with an accessed status notification for the electronic prescription. The secure web resource monitors access to electronic prescription hosted on the secure web portal an sends an accessed status notification to the prescriber through the process that comprises the steps of receiving access request from the secure web portal through the non-networked communication channels, authenticating access by the pharmacy computer module by matching the dispensing pharmacy identifier to the distinct pharmacy identifier associated with the pharmacy computer module, updating the non-accessed status to an accessed status, sending the accessed status to the non-participant routing system through networked communication channels, and transmitting the accessed status to the POC system client. Upon receiving an access request for the secure web portal from the non-networked communication channels, the secure web resource imitates an authentication process. The authentication process is provided as a means of deterring that the accessing client is the pharmacy computer module associated to the distinct pharmacy identifier matching the dispensing pharmacy identifier. This processed can be accomplished by having a user operating pharmacy computer module input the distinct pharmacy identifier or having the secure web portal recognize digital elements that identify the client as being the pharmacy computer module associated with the distinct pharmacy identifier. It should be noted that the system could include a registration process prior to allowing access to the electronic prescription hosted on the secure web portal. After the electronic prescription has been accessed by the pharmacy computer module, the secure web resource updates the non-accessed status to an accessed status. The accessed status is then sent by the secure web resource to the non-participant routing system through networked communication channels. Upon receiving the accessed status the non-participant routing system transmits the accessed status to the POC system client by way of the networked communication channels.

In the current embodiment of the present invention, the point of care system client is provided as any type software system or computerized system that allows for the input of information required to create an electronic prescription. The point of care system client should include a data input method and access to the networked communication channel in order to contact the electronic prescribing network. The point of care system client is utilized to receive the textual input and then transmit the information to the electronic prescribing network. Although the point of care system client carries a description of a singular device, it should be noted that a plurality of electronic devices could function systematically as the point of care system client. Through the use of a network connection provided between the plurality of devices, portions of the information can originate from different components and be sent separately at non specific times in order to form the electronic prescription.

In the current embodiment of the present invention, distinct pharmacy identifier is a numerical identifier utilized to determine a particular dispensing pharmacy. The distinct pharmacy identifier is utilized to determine a destination for the electronic prescription as well as a determinant as to how the electronic prescription should be sent, wherein the electronic prescribing network sends the electronic prescription directly to the dispensing pharmacy's network terminal or to the non participating prescription routing system. The distinct pharmacy identifier is provided as a non specific version of an existing standardized identifier for dispensing pharmacies The National Council for Prescription Drug Program (NCPDP) Provider Identification. The NCPDP provider ID is a unique national identifier that assists pharmacies in their interactions with prescriber's, insurance companies, and patient. To simplify the access of information between the interacting parties, NCPDP provider ids are archived with specific contact information for the particular dispensing pharmacy in a NCPDP pharmacy database. In the current embodiment of the present invention, the established information resource channel is provided as an analogous entity to the NCPDP pharmacy database. The established information resource channel provides the non-participant routing system with a means of obtaining contact information for a non participating dispensing pharmacy.

In the current embodiment of the present invention, pharmacy system client is any type of computing device provided as a means of communication between the dispensing pharmacy and the electronic prescribing network. The pharmacy system client utilizes the networked communication channels as the means of receiving the electronic prescription. The pharmacy system client can consist of a plurality of computing devices that systematically function as a single device. It should be noted that any computing device or system of computing devices can qualify as a pharmacy system client provided that the computing device or system of computing devices are associated with a distinct pharmacy identifier, are able to connect to the networked communication channels, and can receive and utilize electronic prescriptions. Through the aforementioned understanding, the pharmacy computer module can be interpreted as a pharmacy system client so long as the required conditions are met.

In the current embodiment of the present invention, pharmacy telephone receiver is any type of telephonic reception device associated with a distinct pharmacy identifier that utilizes non-networked communication channels as a means of receiving the particular web address and the legally dispensable audio prescription from the non-participant routing system. In the current embodiment pharmacy facsimile receiver is any type of facsimile reception device associated with a distinct pharmacy identifier that utilizes non-networked communication channels as a means of receiving the particular web address and the legally dispensable written prescription from the non-participant routing system;

In the current embodiment of the present invention, the networked communication channels are secure bi-directional communication path ways provided for local and remote communications between the point of care terminal, the electronic prescribing network, the non-participant routing system, and the secure web resource. The networked communication channels can be provided through established communication pathways as long the components are easily identified by the system and provide a secure link for transmitting the various digital items. In the current embodiment of the present invention, the non-networked communication channels are bi-directional communication pathways that are designed for non-specific communications means between network specific components and processes with non network specific devices. The non-networked communication channels are provided as a communication pathway for the non participating routing system and the secure web resource to interact with non-participating dispensing pharmacies. The non-networked communication channels allow a communication pathway through currently available communication means, wherein the currently available communication means are telephone communication channels, facsimile communication channels, as well as digital communication channels such as internet access to a secure web portal.

In an additional embodiment of the present invention, the electronic prescribing network is designed could include the process of transmitting the particular web address to the pharmacy computer module across non-networked communication channels through computer to computer messaging system. this process of transmitting the particular web address to the pharmacy computer module would comprise the steps of receiving the particular web address and the non-accessed status from the secure web resource, generating the prescription availability alert from the particular web address, matching the dispensing pharmacy identifier to the distinct pharmacy identifier in the established information resource channel, locating the pharmacy telephone receiver associated with the distinct pharmacy identifier, transmitting the prescription availability alert to the pharmacy computer module across the non-networked communication channel, generating a delivery status for the transmission of the prescription availability alert to the pharmacy computer module, and transmitting the delivery status and the non-accessed status to the POC system client. Prior to generating the prescription availability alert, the non-participant routing system must receive the particular web address and the non-accessed status from the secure web resource. With the particular web address and the non-accessed status received, the non-participant routing system can generate the prescription availability alert to be transmitted to the pharmacy computer module from the particular web address. The prescription availability alert to be transmitted to the pharmacy computer module provides the dispensing pharmacy with a notification that an electronic prescription is waiting for them and can be accessed across non-networked communication channels at the secure web portal associated with the particular web address. The determination of the non-networked communication channel access path for the pharmacy computer module by the non-participant routing system is accomplished by matching the dispensing pharmacy identifier to the distinct pharmacy identifier in the established information resource channel. While the determination of the access path for the pharmacy telephone receiver and the pharmacy facsimile receiver are known as the telephone number and the fax number, respectively, the access path for the pharmacy computer module may be accomplished through several access paths that can include, email and/or another secure digital messaging means. Unlike the transmission to the pharmacy facsimile receiver and the pharmacy telephone receiver, transmission to the pharmacy computer module does not require the generation of a secondary legally dispensable format. This is due to the fact that the legally dispensable format of the electronic prescription would constitute an electronic prescription. This situation would not be unfavorable since there would be two legally dispensable prescriptions available in the same format. Furthermore security and patient privacy concerns regarding the transmission of an electronic prescription over existing digital messaging means. It should be noted that the transmission to the pharmacy computer module could include the legally dispensable written format and/or the legally dispensable audio format as additional prescription dispensing formats if current security concerns are addressed. During the transmission of the prescription availability alert to the pharmacy telephone receiver, the non-participant routing system generates a delivery status. The delivery status establishes whether the prescription availability alert was received by the pharmacy telephone receiver over the non-networked communication channels. Due possible disruptions in transmissions to the pharmacy computer module, the non-participant routing system attempts to confirm the delivery of the prescription availability alert to the pharmacy computer module. In the event that a transmission to the pharmacy computer module over non-networked communication channels was successful, the non-participant routing system generates a positive delivery status. In the event that a transmission to the pharmacy computer module over non-networked communication channels was not successful, the non-participant routing system generates a negative delivery status. In either event, the delivery status notification would be sent to POC system client alerting the prescriber of the delivery attempt.

Although the invention has been explained in relation to its preferred embodiment, it is to be understood that many other possible modifications and variations can be made without departing from the spirit and scope of the invention as hereinafter claimed.

What is claimed is:

1. A method of routing an electronic prescription to a non-participating dispensing pharmacy by executing computer-executable instructions stored on a non-transitory computer-readable medium, the method comprises the steps of:
providing a point of care (POC) system client;
providing a dispensing pharmacy, wherein the dispensing pharmacy comprises a pharmacy system client, a pharmacy telephone receiver, a pharmacy facsimile receiver, and a pharmacy computer module;
providing a distinct pharmacy identifier for the dispensing pharmacy;
providing networked communication channels and non-networked communication channels;
providing an electronic prescribing network, wherein the electronic prescribing network comprises a participant routing system, a non-participant routing system, and a participant database, wherein the non-participant routing system comprises a secure web resource, and the participant database comprises a plurality of dispensing pharmacy identifiers;
generating an electronic prescription at the POC system client;
transmitting the electronic prescription and a dispensing pharmacy identifier to the electronic prescribing network;
comparing the dispensing pharmacy identifier to the plurality of dispensing pharmacy identifiers stored within the participant database;
transmitting the electronic prescription to the pharmacy system client,
if the plurality of dispensing pharmacy identifiers contains the distinct pharmacy identifier;
transferring the electronic prescription to the non-participant routing system,
generating a secure web portal for hosting the electronic prescription,
transmitting a prescription availability alert to the dispensing pharmacy through the non-networked communication channels,
monitoring access to the secure web portal by way of the secure web resource,
if the plurality of dispensing pharmacy identifiers does not contain the distinct pharmacy identifier; and
transmitting a status notification to the POC system client.

2. The method of routing an electronic prescription to a non-participating dispensing pharmacy by executing computer-executable instructions stored on a non-transitory computer-readable medium, in claim 1, wherein the dispensing pharmacy, the pharmacy system client, the pharmacy telephone receiver, the pharmacy facsimile receiver, and the pharmacy computer module are inherently associated with the distinct pharmacy identifier.

3. The method of routing an electronic prescription to a non-participating dispensing pharmacy by executing computer-executable instructions stored on a non-transitory computer-readable medium, as claimed in claim 1 comprises the steps of:
receiving a prescription drug order at the POC system client;
generating the electronic prescription from the prescription drug order;
receiving the dispensing pharmacy identifier at the POC system client;
associating the electronic prescription with the dispensing pharmacy identifier; and
transmitting the electronic prescription and the dispensing pharmacy identifier from the POC system client to the electronic prescribing network across the networked communication channels.

4. The step of transmitting the electronic prescription to the pharmacy system client by executing computer-executable instructions stored on a non-transitory computer-readable medium, as claimed in claim 1 further comprises the steps of:
matching the dispensing pharmacy identifier to the distinct pharmacy identifier contained within the plurality of dispensing pharmacy identifiers;
transferring the electronic prescription and the distinct pharmacy identifier to the participant routing system;
locating the pharmacy system client associated with the distinct pharmacy identifier;
transmitting the electronic prescription to the pharmacy system client across the networked communication channels;
generating a delivery status notification for the transmission of the electronic prescription to the pharmacy system client; and
transmitting the delivery status notification to the POC system client.

5. The step of transferring the electronic prescription to the non-participant routing system by executing computer-executable instructions stored on a non-transitory computer-readable medium, as claimed in claim 1 further comprises the steps of:
determining no match contained within the plurality of dispensing pharmacy identifiers for the dispensing pharmacy identifier;
transferring the electronic prescription and the dispensing pharmacy identifier to the non-participant routing system;
generating a digital copy of the electronic prescription and the dispensing pharmacy identifier; and
transmitting the digital copy to the secure web resource across the networked communication channels.

6. The step of generating the secure web portal by executing computer-executable instructions stored on a non-transitory computer-readable medium, as claimed in claim 1 further comprises the steps of:
receiving a digital copy of the electronic prescription and the dispensing pharmacy identifier at the secure web resource, across the networked communication channels;
generating the secure web portal for the electronic prescription;
generating a particular web address associated with the secure web portal;
hosting the electronic prescription at the secure web portal for access by the pharmacy computer module through non-networked communication channels;
generating a non-accessed status for the electronic prescription hosted on the secure web portal; and
transferring the particular web address and the non-accessed status to the non-participant routing system through networked communications channels.

7. The step of transmitting the prescription availability alert by executing computer-executable instructions stored on a non-transitory computer-readable medium, as claimed in claim 1 comprises the steps of:
providing a particular web address and a non-accessed status;
providing an established information resource channel;
generating a legally dispensable human readable prescription from the electronic prescription;
receiving the particular web address and the non-accessed status from the secure web resource;
generating the prescription availability alert from the particular web address and the legally dispensable human readable prescription;
matching the dispensing pharmacy identifier to the distinct pharmacy identifier in the established information resource channels;
locating the dispensing pharmacy associated with the distinct pharmacy identifier;
transmitting the prescription availability alert to dispensing pharmacy across the non-networked communication channel;
generating a delivery status for the transmission of the prescription availability alert to the dispensing pharmacy; and
transmitting the delivery status and the non-accessed status to the POC system client.

8. The step of transmitting the prescription availability alert by executing computer-executable instructions stored on a non-transitory computer-readable medium, as claimed in claim 7 further comprises the steps of:
generating a legally dispensable facsimile prescription from the electronic prescription;
receiving the particular web address and the non-accessed status from the secure web resource;
generating the prescription availability alert from the particular web address and the legally dispensable facsimile prescription;
matching the dispensing pharmacy identifier to the distinct pharmacy identifier in the established information resource channels;
locating the pharmacy facsimile receiver associated with the distinct pharmacy identifier;
transmitting the prescription availability alert to the pharmacy facsimile receiver across the non-networked communication channel;
generating a delivery status for the transmission of the prescription availability alert to the pharmacy facsimile receiver; and
transmitting the delivery status and the non-accessed status to the POC system client.

9. The step of transmitting the prescription availability alert by executing computer-executable instructions stored on a non-transitory computer-readable medium, as claimed in claim 7 further comprises the steps of:
generating a legally dispensable audio prescription from the electronic prescription;
receiving the particular web address and the non-accessed status from the secure web resource;
generating the prescription availability alert from the particular web address and the legally dispensable audio prescription;
matching the dispensing pharmacy identifier to the distinct pharmacy identifier in the established information resource channel;
locating the pharmacy telephone receiver associated with the distinct pharmacy identifier;
transmitting the prescription availability alert to the pharmacy telephone receiver across the non-networked communication channel;
generating a delivery status for the transmission of the prescription availability alert to the pharmacy telephone receiver; and
transmitting the delivery status and the non-accessed status to the POC system client.

10. The step of monitoring access to the secure web portal by executing computer-executable instructions stored on a non-transitory computer-readable medium, as claimed in claim 1 further comprises the steps of:
receiving an access request for the secure web portal from the pharmacy computer module by way of the non-networked communication channels;
authenticating the access request of pharmacy computer module, wherein the authentication occurs by matching the dispensing pharmacy identifier to the distinct pharmacy identifier associated with the pharmacy computer module;
transferring the electronic prescription to the pharmacy computer module;
updating the non-accessed status to an accessed status; and
transmitting the accessed status to the POC system client by way of networked communication channels.

11. A method of routing an electronic prescription to a non-participating dispensing pharmacy by executing computer-executable instructions stored on a non-transitory computer-readable medium, the method comprises the steps of:
providing a point of care (POC) system client;
providing a dispensing pharmacy, wherein the dispensing pharmacy comprises a pharmacy system client, a pharmacy telephone receiver, a pharmacy facsimile receiver, and a pharmacy computer module;
providing a distinct pharmacy identifier for the dispensing pharmacy, wherein the dispensing pharmacy, the pharmacy system client, the pharmacy telephone receiver, the pharmacy facsimile receiver, and the pharmacy computer module are inherently associated with the distinct pharmacy identifier;
providing networked communication channels and non-networked communication channels;
providing an electronic prescribing network, wherein the electronic prescribing network comprises a participant routing system, a non-participant routing system, and a participant database, wherein the non-participant routing system comprises a secure web resource, and the participant database comprises a plurality of dispensing pharmacy identifiers;
generating an electronic prescription at the POC system client;
transmitting the electronic prescription and a dispensing pharmacy identifier to the electronic prescribing network;
comparing the dispensing pharmacy identifier to the plurality of dispensing pharmacy identifiers stored within the participant database;
transmitting the electronic prescription to the pharmacy system client,
if the plurality of dispensing pharmacy identifiers contains the distinct pharmacy identifier;
transferring the electronic prescription to the non-participant routing system,
generating a secure web portal for hosting the electronic prescription,
transmitting a prescription availability alert to the dispensing pharmacy through the non-networked communication channels,
monitoring access to the secure web portal by way of the secure web resource,
if the plurality of dispensing pharmacy identifiers does not contain the distinct pharmacy identifier; and
transmitting a status notification to the POC system client.

12. The method of routing an electronic prescription to a non-participating dispensing pharmacy by executing computer-executable instructions stored on a non-transitory computer-readable medium, as claimed in claim 11 comprises the steps of:
receiving a prescription drug order at the POC system client;
generating the electronic prescription from the prescription drug order;
receiving the dispensing pharmacy identifier at the POC system client;
associating the electronic prescription with the dispensing pharmacy identifier; and
transmitting the electronic prescription and the dispensing pharmacy identifier from the POC system client to the electronic prescribing network across the networked communication channels.

13. The step of transmitting the electronic prescription to the pharmacy system client by executing computer-executable instructions stored on a non-transitory computer-readable medium, as claimed in claim 11 further comprises the steps of:
matching the dispensing pharmacy identifier to the distinct pharmacy identifier contained within the plurality of dispensing pharmacy identifiers;
transferring the electronic prescription and the distinct pharmacy identifier to the participant routing system;
locating the pharmacy system client associated with the distinct pharmacy identifier;
transmitting the electronic prescription to the pharmacy system client across the networked communication channels;
generating a delivery status notification for the transmission of the electronic prescription to the pharmacy system client; and
transmitting the delivery status notification to the POC system client.

14. The step of transferring the electronic prescription to the non-participant routing system by executing computer-executable instructions stored on a non-transitory computer-readable medium, as claimed in claim 11 further comprises the steps of:
determining no match contained within the plurality of dispensing pharmacy identifiers for the dispensing pharmacy identifier;
transferring the electronic prescription and the dispensing pharmacy identifier to the non-participant routing system;
generating a digital copy of the electronic prescription and the dispensing pharmacy identifier;
transmitting the digital copy to the secure web resource across the networked communication channels;
generating the secure web portal for the electronic prescription;
generating a particular web address associated with the secure web portal;
hosting the electronic prescription at the secure web portal for access by the pharmacy computer module through non-networked communication channels;
generating a non-accessed status for the electronic prescription hosted on the secure web portal;
transferring the particular web address and the non-accessed status to the non-participant routing system through networked communications channels;
generating a legally dispensable human readable prescription from the electronic prescription;
generating the prescription availability alert from the particular web address and the legally dispensable human readable prescription;
matching the dispensing pharmacy identifier to the distinct pharmacy identifier in the established information resource channels;
locating the dispensing pharmacy associated with the distinct pharmacy identifier;
transmitting the prescription availability alert to dispensing pharmacy across the non-networked communication channel;
generating a delivery status for the transmission of the prescription availability alert to the dispensing pharmacy;
transmitting the delivery status and the non-accessed status to the POC system client;
receiving an access request for the secure web portal from the pharmacy computer module by way of the non-networked communication channels;
authenticating the access request of pharmacy computer module, wherein the authentication occurs by matching the dispensing pharmacy identifier to the distinct pharmacy identifier associated with the pharmacy computer module;
transferring the electronic prescription to the pharmacy computer module;
updating the non-accessed status to an accessed status; and
transmitting the accessed status to the POC system client by way of networked communication channels.

15. The step of transmitting the prescription availability alert by executing computer-executable instructions stored on a non-transitory computer-readable medium, as claimed in claim 14 further comprises the steps of:
generating a legally dispensable facsimile prescription from the electronic prescription;
receiving the particular web address and the non-accessed status from the secure web resource;
generating the prescription availability alert from the particular web address and the legally dispensable facsimile prescription;
matching the dispensing pharmacy identifier to the distinct pharmacy identifier in the established information resource channels;
locating the pharmacy facsimile receiver associated with the distinct pharmacy identifier;
transmitting the prescription availability alert to the pharmacy facsimile receiver across the non-networked communication channel;
generating a delivery status for the transmission of the prescription availability alert to the pharmacy facsimile receiver; and
transmitting the delivery status and the non-accessed status to the POC system client.

16. The step of transmitting the prescription availability alert by executing computer-executable instructions stored on a non-transitory computer-readable medium, as claimed in claim 14 further comprises the steps of:
generating a legally dispensable audio prescription from the electronic prescription;
receiving the particular web address and the non-accessed status from the secure web resource;
generating the prescription availability alert from the particular web address and the legally dispensable audio prescription;
matching the dispensing pharmacy identifier to the distinct pharmacy identifier in the established information resource channel;
locating the pharmacy telephone receiver associated with the distinct pharmacy identifier;
transmitting the prescription availability alert to the pharmacy telephone receiver across the non-networked communication channel;
generating a delivery status for the transmission of the prescription availability alert to the pharmacy telephone receiver; and
transmitting the delivery status and the non-accessed status to the POC system client.

17. A method of routing an electronic prescription to a non-participating dispensing pharmacy by executing computer-executable instructions stored on a non-transitory computer-readable medium, the method comprises the steps of:
providing a point of care (POC) system client;
providing a dispensing pharmacy, wherein the dispensing pharmacy comprises a pharmacy system client, a pharmacy telephone receiver, a pharmacy facsimile receiver, and a pharmacy computer module;
providing a distinct pharmacy identifier for the dispensing pharmacy, wherein the dispensing pharmacy, the pharmacy system client, the pharmacy telephone receiver, the pharmacy facsimile receiver, and the pharmacy computer module are inherently associated with the distinct pharmacy identifier;
providing networked communication channels and non-networked communication channels;
providing an electronic prescribing network, wherein the electronic prescribing network comprises a participant routing system, a non-participant routing system, and a participant database, wherein the non-participant routing system comprises a secure web resource, and the participant database comprises a plurality of dispensing pharmacy identifiers;
receiving a prescription drug order at the POC system client;
generating the electronic prescription from the prescription drug order;
receiving the dispensing pharmacy identifier at the POC system client;
associating the electronic prescription with the dispensing pharmacy identifier;
transmitting the electronic prescription and a dispensing pharmacy identifier to the electronic prescribing network;
comparing the dispensing pharmacy identifier to the plurality of dispensing pharmacy identifiers stored within the participant database;
matching the dispensing pharmacy identifier to the distinct pharmacy identifier contained within the plurality of dispensing pharmacy identifiers,
transferring the electronic prescription and the distinct pharmacy identifier to the participant routing system,
locating the pharmacy system client associated with the distinct pharmacy identifier,
transmitting the electronic prescription to the pharmacy system client across the networked communication channels,
generating a delivery status notification for the transmission of the electronic prescription to the pharmacy system client, and
transmitting the delivery status notification to the POC system client,
if the plurality of dispensing pharmacy identifiers contains the distinct pharmacy identifier;
determining no match contained within the plurality of dispensing pharmacy identifiers for the dispensing pharmacy identifier,
transferring the electronic prescription and the dispensing pharmacy identifier to the non-participant routing system,
generating a digital copy of the electronic prescription and the dispensing pharmacy identifier,
transmitting the digital copy to the secure web resource across the networked communication channels,
generating the secure web portal for the electronic prescription,
generating a particular web address associated with the secure web portal,
hosting the electronic prescription at the secure web portal for access by the pharmacy computer module through non-networked communication channels,
generating a non-accessed status for the electronic prescription hosted on the secure web portal,
transferring the particular web address and the non-accessed status to the non-participant routing system through networked communications channels,
generating a legally dispensable human readable prescription from the electronic prescription,
generating the prescription availability alert from the particular web address and the legally dispensable human readable prescription,
matching the dispensing pharmacy identifier to the distinct pharmacy identifier in the established information resource channels,
locating the dispensing pharmacy associated with the distinct pharmacy identifier,
transmitting the prescription availability alert to dispensing pharmacy across the non-networked communication channel,
generating a delivery status for the transmission of the prescription availability alert to the dispensing pharmacy,
transmitting the delivery status and the non-accessed status to the POC system client,
receiving an access request for the secure web portal from the pharmacy computer module by way of the non-networked communication channels,
authenticating the access request of pharmacy computer module, wherein the authentication occurs by matching the dispensing pharmacy identifier to the distinct pharmacy identifier associated with the pharmacy computer module,
transferring the electronic prescription to the pharmacy computer module,
updating the non-accessed status to an accessed status, and
transmitting the accessed status to the POC system client by way of networked communication channels,
if the plurality of dispensing pharmacy identifiers does not contain the distinct pharmacy identifier; and
transmitting a status notification to the POC system client.

18. The step of transmitting the prescription availability alert by executing computer-executable instructions stored on a non-transitory computer-readable medium, as claimed in claim 17 further comprises the steps of:
generating a legally dispensable facsimile prescription from the electronic prescription;
receiving the particular web address and the non-accessed status from the secure web resource;
generating the prescription availability alert from the particular web address and the legally dispensable facsimile prescription;
matching the dispensing pharmacy identifier to the distinct pharmacy identifier in the established information resource channels;
locating the pharmacy facsimile receiver associated with the distinct pharmacy identifier;
transmitting the prescription availability alert to the pharmacy facsimile receiver across the non-networked communication channel;
generating a delivery status for the transmission of the prescription availability alert to the pharmacy facsimile receiver; and
transmitting the delivery status and the non-accessed status to the POC system client.

19. The step of transmitting the prescription availability alert by executing computer-executable instructions stored on a non-transitory computer-readable medium, as claimed in claim 17 further comprises the steps of:
generating a legally dispensable audio prescription from the electronic prescription;
receiving the particular web address and the non-accessed status from the secure web resource;
generating the prescription availability alert from the particular web address and the legally dispensable audio prescription;
matching the dispensing pharmacy identifier to the distinct pharmacy identifier in the established information resource channel;
locating the pharmacy telephone receiver associated with the distinct pharmacy identifier;
transmitting the prescription availability alert to the pharmacy telephone receiver across the non-networked communication channel;
generating a delivery status for the transmission of the prescription availability alert to the pharmacy telephone receiver; and
transmitting the delivery status and the non-accessed status to the POC system client.
